(19) United States
(12) Patent Application Publication
(10) Pub. No.: US 2008/0159491 A1
(43) Pub. Date: Jul. 3, 2008

(54) System For the Management and Use of Information From Voice Input

(75) Inventors: Timothy D. Kelley, Erie, CO (US); John C. Kelley Jr., Erie, CO (US); Franklin D. Cordell, Greeley, CO (US)

Correspondence Address: SANTANGELO LAW OFFICES, P.C., 125 SOUTH HOWES, THIRD FLOOR, FORT COLLINS, CO, 80521, US

(73) Assignee: VERBAL WORLD, INC., Broomfield, CO (US)

(21) Appl. No.: 11/815,437

(22) PCT Filed: Feb. 2, 2006
(86) PCT No.: PCT/US06/04225

§ 371 Date: Aug. 2, 2007

Related U.S. Application Data
(60) Provisional application No. 60/649,719, filed on Feb. 2, 2005.

(51) Int. Cl. H04M 3/533

(52) U.S. Cl. 379/88.16

(57) ABSTRACT

A voice based information system configurable to serve and facilitate efficient voice messaging, voice based parameters, voice based reporting, voice based calendaring, and voice retailing includes systems that use some voice capable device (1) that provides information to an interface (2) for additional processing by some or all of various elements (3) to (8) perhaps with an output generator (9) for delivery to a user or system (10). Configurations for different functions and applications are disclosed.

### TECHNICAL FIELD

Generally, this invention relates to a system for interactive voice management of information and systems configured to handle voice information in an efficient manner.

### BACKGROUND

This invention may be embodied in a phone, or computer system. It may also involve functionality relative to any one or more of creation and use of database and structured information, interactive scheduling by voice, multimodal communication, voice notepad functions, voice interaction with web sites, remote reporting, expanding retail opportunities, or perhaps even managing contacts. Specifically, embodiments of the invention focus on convenient applications, methods, software, hardware, services, and even business methods which can provide a variety of functions important in verbally or otherwise scheduling events, appointments and resources; communicating using email, voice, text, images, video or perhaps even stored files, data, text or voice; verbally managing multimodal information; verbally entering or manipulating data, files, notes or multimodal documents including but not limited to those types used for business, human services or even personal documents; providing scheduled services such as reminding users of upcoming events or dates of interest; providing access to web or network-based functions by voice, such as ordering items; accessing network- or computer-based resources, or even processing information; storing or accessing voice, text, documents, images, video or even processing by people when software cannot be written for a given function; or providing the infrastructure or system for specialized networks of interest to some users of such a system.

### DISCLOSURE OF THE INVENTION

As mentioned earlier, the present invention may include a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments or claims should not be construed to limit the present invention to only the explicitly described systems, techniques, and applications. Further, this description should be understood to support and encompass descriptions or claims of all the various embodiments, systems, techniques, methods, devices, and applications with any number of the disclosed elements, with each element alone, and also with any and all various permutations and combinations of all elements and all permutations and combinations of any claim dependencies in this or any subsequent application.

Conceptually, the invention can be presented and understood by reference to a variety of potentially separate aspects, including but not limited to: a cellular phone or other voice communicating capability; a functionality for creating and managing database and structured information from verbal or perhaps multimodal input; a functionality for sending and receiving email by voice through software and applications; a functionality for entering and manipulating notes, reports, or documents by voice through software and applications, a functionality for interacting with web sites by voice through software and applications, a functionality for interacting with a calendar by voice including but not limited to trapping a date for a specific use, reminding users of that specific use, and doing something on that date such as triggering a phone call(s), or remotely triggering software functions on a network through software and applications; a functionality for generating reports by using voice commands, a functionality for reminding, offering, or even suggesting a relevant retail opportunity, or the like. Each of these functionalities can interact with any other functionality to create a new order or combination of functionality. Some of these functions are depicted conceptually in the attached figure. Further, certain aspects are described in U.S. Pat. No. 6,766,328 B2 entitled “System for the Creation of Database and Structured Information from Verbal Input”, hereby incorporated by reference. Each of all the aspects described herein can of course be presented and used separately or they may be combined with any combination or permutation of these or other aspects to present an overall system.

### BRIEF DESCRIPTION OF DRAWINGS

FIG. 1 is a conceptual diagram of the interaction aspects of some embodiments of the invention.

FIG. 2 is a block diagram appropriate to a variety of apparatus configurations according to some embodiments of the invention.

### MODE(S) FOR CARRYING OUT THE INVENTION

In some embodiments, a standard telephone, a cellular phone, more generically a voice capable communications device, or other voice communicating capability aspect may be used to accomplish or input the desired action. This aspect may generally relate to and may provide capabilities for a seamless, easy-to-use, front-end, interactive, voice interface for individual users to interact by voice with the system of a particular embodiment, including but not limited to a private calendar, email system or report generator, or to be called by their calendar to be reminded of a scheduled event or to be given information relevant to the scheduled event. This front-end, perhaps interactive, perhaps voice communicating capability may include a cellular or other phone or device or service of any sort, a cellular or other phone or device or service with computing capability, a cellular or other phone or device or service with voice recognition or other functionality, a landline or other phone or device or service with or without computing functionality, or even a PDA with recording, digitizing or downloading functionality. Specifically, this aspect of the invention may focus on or may provide for prompting the user to facilitate digitizing voice for use in other aspects of the invention.

Perhaps one of the problems that this invention may address is the ability to command and interact with a computing device by voice, enter information by voice, interacting with a calendar by voice, more efficiently sending and receiving email by voice, ordering items from selected or network retailers or other businesses by voice, interacting with web sites or other network resources by voice, or even perhaps accessing stored information by voice perhaps even without the use of keystrokes or in a completely mobile environment.

In some embodiments, a functionality for creating or managing database or structured information, such as may be established in a computer controlled report paradigm, namely data structured in a manner that can be accessed as appropriate for any one of a broad variety of reporting desires or the like, from verbal or multimodal input may be included. Some relevant functionality is described by U.S. Pat. No. 6,766,328 B2 and is hereby incorporated in this patent by reference.

Perhaps another problem that this invention may address is the creation of structured information from verbal input, thus adding significant functionality to existing interactive voice response systems. Functionality for sending and receiving email by voice through software and applications may also be included. This aspect of the invention generally relates to and may provide capabilities for a perhaps seamless, easy-to-use, voice-based email system that may allow the user to send email by voice, including the body text as a wave (.wav) or similar file or perhaps even be converted and sent as text or some other word processing compatible file. It may even send video or attachments from a directory of items such as but not limited to stored text, documents, voice, pictures, tables, graphics, animated graphics, video clips, formatted presentations, or otherwise. This may also be accomplished in a multimodal format if desired. The functionality for sending and receiving email by voice through software and application may also allow the user to send it as voice in any format or to convert and send it as text. Additionally, the user may both send email to an IP address or a Pop Server, or may receive email from an IP address or a POP Server. In some embodiments, additional functionality may also allow the user to search and/or sort email by date and time, by author either to or from, or even by subject. The functionality for sending and receiving email may even allow the user to broadcast email by group, by list, or perhaps by subject.

The functionality for sending and receiving email by voice may also allow the user to interact with a calendar functionality by connections for calendar function or even Crontab mail distributions. This functionality may allow a user to interact with a report generating functionality from the email functionality perhaps by providing connection for report functions and even templates for data insertion. The email functionality may also support the use of telephone routing or send functionalities.

A significant problem that some embodiments may also address is to create a perhaps custom application through which a user can compose and send emails using voice instead of a keyboard, can use a well-tested mobile technology, can attach items from a directory, can add information to text or graphic messages by voice over functionality, or can access by voice the subject line and/or body text of email received.

Functionality for entering, storing or even manipulating notes or documents by voice through software and applications may also be included in some embodiments. This aspect of the invention generally relates to and may provide capability for the entry of notes by voice into a calendar or database, searching out or appending information stored or contained in the system, storing such notes or documents in electronic form either as a voice file, text, graphics, animated graphics or video, or perhaps manipulating or formatting such notes, and even retrieving such notes.

Embodiments of the invention may address the capability of entering, manipulating, storing, retrieving, or emailing information or using network resources or even separate third party resources to manage information perhaps by voice with a simple device such as a cellular or landline phone.

A functionality for interacting with web sites by voice through software and applications can also be included in some embodiments. This aspect of the invention may also provide capabilities for perhaps a seamless, easy-to-use voice portal to web or other sites. This functionality may allow the user of the system to enter orders, track orders, or to communicate information about such orders to individuals or groups by voice or the like.

Additionally, a functionality may allow a user to perform other functions on web sites. Web sites function as the interface with many kinds information processing, indeed for many kinds of activities or businesses. A simple example might be a business that provides a whole series of services for businesses, such as receiving documents, text, or pictures or graphics electronically, composing or formatting documents from the electronic input, printing or making copies of them, collating the copies, binding those copies and may even provide editing and delivery services, delivering them to multiple addresses either by electronic means or physically delivering them perhaps through a delivery service or postal service. Such multimodal documents might include electronic presentations, business proposals, or even multimodal communications such as animated greeting cards with voice over, thank you letters with video and voice messages etc. This same business or another business might do transcription of dictated notes or content, may provide correction or editing of text created by automatic voice recognition and then may format the document and provide other services. Any and all of these businesses might interface with the present system for the management of information and the like perhaps from voice input via a web site on the Internet. Embodiments of the system may allow the user to purchase or take advantage of such services by facilitating an interaction with the web site of the underlying business.

Another example might be commanding or controlling by voice through one system, a second perhaps remote system. As but one example, this may include an “electronic house” that has centralized electronic thermostats, a security system, or other appliances. In one embodiment, a user could by voice command the system to turn down the air conditioning and review the status of the security system.

Another example of interfacing with a functionality by voice using an embodiment of the system might be to call up and command a search engine, receive a report from the search engine, select and open documents found by the search engine, and perhaps even use a text to speech functionality to report all or some content of the document to the user by voice.

Another aspect that embodiments of this invention might include is a functionality such as is found on a variety of web sites including but not limited to those that search the World Wide Web, that gather and process information, that permit ordering or purchasing items from Internet stores, or the like. Embodiments may even accomplish these types of functions by voice with one simple voice communication device perhaps with capabilities either isolated from or even integral to the underlying web sites.

Embodiments may include functionality for interacting with a calendar by voice through software and applications. This aspect of the invention generally relates to and may provide capabilities for using an interactive voice calendar to identify dates and times available for entries from either voice input or stored voice input, to select multiple users or groups from a company list, department list, contractors list, patient list or family or friends list or the like; to analyze group schedules and select open times through database operations to access date and time options, and even do tentative or final scheduling by weighted time for overwrite and cancel functions; to analyze resource schedules and select open times for such resources as real estate, e.g., buildings, rooms, conference centers and the like; hardware and equipment such as audio visual equipment, computers, or tools available for rent; and industrial equipment such as trucks, tractors, aircraft, cars and heavy equipment.

An interactive voice calendar functionality for some embodiments may allow for entry of body messages and updates for each scheduled date and time such as wave (.wav) files or any voice recording, text files in any format, digital image files such as JPEG (.jpg) or any digital format, video files such as MPEG (.mpg) format etc. and animation files in any format such a through a recorder of some type or the like.

Further, an interactive voice calendar functionality may be included and may allow for attachment of wave (.wav) files or any voice recording, digital image files such as JPEG (.jpg) or any other format, video files in any video format such as MPEG (.mpg), text files in any format such as Word or Excel, and animation files in any format. Further, the interactive voice calendar functionality may allow for a system to notify users of the system of a date or time in selectable increments by telephone to a user at a prescribed time, to email an account, or even to send messages to pager services. Further, the interactive voice calendar functionality may be included such as might allow for a cancel feature for either individual or group events. Further, an interactive voice calendar functionality may be included that may allow for the notification of an individual or a group of the date and/or time of an event by telephone, email or pager services. Further, an interactive voice calendar functionality may also allow for a bundling of events into a quick update to individuals or groups including but not limited to daily events, hourly events, new messages, or new schedules.

Some embodiments may further include an interactive voice calendar functionality that may allow for the placing of orders or otherwise interacting with websites in the business of selling products or services, and may even allow the user to select from a predetermined list of vendors, or to find a new vendor by price, location, product or service. This functionality may also allow the user to track order information back to the calendar date and interact with email confirmation and may even allow for the insertion of a confirmation message into the date and time.

An interactive voice calendar functionality may also allow for support by mail servers by providing for accessing email accounts for specific information, and to send and receive email messages. Additionally, an interactive voice calendar functionality may be included such as might allow for support by telephone servers by accessing voice mail servers for messages, placing phone calls at prescribed times that may include an audio message, and place a page at a prescribed time.

An interactive voice calendar functionality may also allow for report functions including but not limited to usage reports including resources used, attachments, and archive and retrieval functions.

Further, an interactive voice calendar functionality may also allow for interacting with web servers and may also allow the system to connect to multiple servers, to place orders, to concatenate confirmations and even to make group orders.

Embodiments of the invention may also provide a capability to access important information, the ability to manipulate, process and format information, or to deliver it to individuals or groups by voice with one simple device.

Embodiments of the invention may include a functionality for generating reports by using voice commands or the like. This aspect of the invention generally relates to and may provide capabilities for a perhaps seamless, easy-to-use report creation capability, electronic storing capability, voice accessing capability, information manipulation capability, printing capability or perhaps even delivery capability. For example, a user may be able to create business reports with voice for such uses including but not limited to expense reports, travel, sales and management reporting or the like. This functionality may even allow the user to create scheduling reports with voice for such things as personnel, hardware, equipment, timeline in either a Program Evaluation and Review Technique or Just In Time format. The report functionality may create usage reports with voice for such topics as materials or resources. Functionality may allow a user to use voice to search or sort reports by author, date/time, subject or even type. Report functionality may allow a user to use voice to archive or retrieve from archives reports by date range, type and subject.

In some embodiments, a report functionality may allow a user to interact with email or calendar functionality by voice or may allow a user to send, receive or broadcast reports by email or to interact with information contained in a calendar.

Embodiments of the invention may address entering, manipulating, accessing, archiving, printing and electronically communicating information by voice.

Facets may include many functionalities in the form of applications, methods, software, firmware, hardware, services, and even business methods which can provide a variety of capabilities important to the invention. It may be possible to build some of the functions in routines that can be called from existing software such as Microsoft SpeechServer or the like, even though existing routines might need to be significantly modified or repurposed to be able to function as separate applications activated by voice responses.

Through such functionalities, email or other services might be able to receive data from outside sources. Embodiments of the invention might be able to perceive new mail from old mail to determine if the user needs to be notified and then might alert a user to new mail by calling the user or perhaps even paging the user. Each email message may also have a subject line. The invention might also contain voice based sort functions or perhaps the capability of linking the subject line to the message for archive and retrieval.

In this regard, facets might include functionality for inserting attachments by voice. Such functionality could create or include a capability to insert attachments of any kind of digital file, including text documents, voice files, graphics, animated graphics, video into calendar, or even email functions.

Embodiments could include a text-to-speech (TTS) engine perhaps that could read many or any data file from many or any source. Text files could be opened from a speech database. Embodiments of the invention might be configured to open any text file whether in Word™, text or open format.

Embodiments of the invention could include a speech-to-text (STT) engine that can convert spoken language or perhaps portions thereof into readable text. Such an engine need not even be 100% correct, but rather it might merely create a useable dialog or may provide a speech file for accuracy backup.

Embodiments could include functionality to create multiple users or groups for the distribution of messages, the provision of services, or for acquiring permissions, or the like.

Some embodiments may include a capability for a date and time function. Such could even be a tag for a data file or become the database for archived files. The functions that could be associated with this tag include but are not limited to: create data tag for the information, trigger ordering functions, or recall or transmit functions.

Embodiments may contain analyzing functionality that may notify or work multiple functions for email arrivals, open scheduling or even analysis of usage.

Aspects of the invention could include weighted analysis functionality perhaps even written into code that can be called from a voice application platform. One aspect of such an embodiment may be to be able to scale or resource, time or commitment.

In some embodiments, the invention could include functionality that may allow the applications to interact with voice systems, including but not limited to the configuration of dialogic cards or programs or the like.

Embodiments of the invention may also give the user a capability to interact with web platforms by voice. The invention could provide functionality to access information such as weather, stocks or even travel information or the like by voice. Further, the invention could provide functionality to interact by voice with web platforms that could provide products and services by E-commerce.

Embodiments of the invention may provide functionality that may give a user a capability to interact with a database, including but not limited to interactions such as involved in data storage, archive, retrieval or analysis. Each of these may be accomplished by voice, of course.

As mentioned, the invention may be configured in a variety of embodiments; several of these are now specifically detailed. One such embodiment may be as a system through which method of providing voice based message information may be accomplished. Voice based message information may be any message information capable of being or actually expressed by voice.

To accomplish this, certain embodiments may include establishing an automated voice based information entry interface. The term automated may be understood to include a capability to engage in substantially self-directed action, perhaps self-directed action as may be possible without or with limited human intervention, and perhaps as may be indicated by computer-implemented action. An voice based information entry interface may be understood to include an interface that permits entry of voice based information, for example as may be accomplished by items including microphones, telephones, voice recorders, and the like.

Various embodiments may include providing at least one voice based parameter identifier. A voice based parameter may be understood to include a parameter indicated by voice information. Examples of a voice based parameter may perhaps include a subset of such voice information, as perhaps a sentence (e.g. “This included business.”), word (e.g. “personal”), or even phoneme (e.g. “bus” or “pers”). Examples of a voice based parameter may further include separately articulated voice information, for example voice information which perhaps may not be included in an original voice based message but may perhaps be separately vocalized, prompted, or appended to such original voice based message. A voice based parameter identifier may be understood to include an element of a voice based information entry interface capable of identifying a voice based parameter of voice based information.

Some embodiments may include accepting at least one voice based message through an automated voice based information entry interface. In this context, the term accepting may be understood to involve any action by which voice based information may be processed successfully by a voice based information entry interface.

Certain embodiments may include automatically assigning at least one voice based parameter to said voice based message. In this context, the term assigning may be understood to include any action by which a voice based parameter may be associated with a voice based message.

Some embodiments may include automatically storing a voice based message and a voice based parameter. Storing may be understood to include fixing any suitable form, including perhaps in analog media or perhaps digital media, suitable for recovery and use at a future time. These two aspects may be stored separately or may merely be tagged or indicated as existing in one storage location.

Various embodiments may include establishing an automated voice capable information entry interface. The term voice capable may be understood to include retaining a capability of interfacing with voice data, but perhaps not limited to only interfacing with voice data.

Certain embodiments may include providing at least one subject based parameter identifier. A subject based parameter may be understood to include a parameter of information related to the subject of such information (e.g., a subject line, synopsis, or the like). Examples of a subject based parameter may perhaps include a subset of such information itself, as perhaps a sentence, word, or even phoneme of voice based information as discussed earlier. Examples of a subject based parameter may further include separately articulated subject information, for example subject information which perhaps may not be included or automatically discerned from an original message but which may perhaps be separately articulated and appended to such original information. A subject based parameter identifier may be understood to integrate with an element of a voice capable information entry interface capable of identifying a subject based parameter of voice based information.

Some embodiments may include accepting at least once voice based message through an automated voice capable information entry interface. In this context, the term accepting may be understood to involve any action by which voice based information may be processed by a voice capable information entry interface.

Some embodiments may further include automatically assigning at least one subject based parameter to a voice based message. In this context, the term assigning may be understood to include any action by which a subject based parameter may be associated with a voice based message.

Various embodiments may further include automatically storing said voice based message and said subject based parameter. Storing may be understood to include fixing any suitable form, including perhaps in analog media or perhaps digital media, suitable for recovery and use at a future time, either separately or as one, as discussed earlier.

As mentioned, the invention may be configured in a variety of embodiments. Another embodiment may be as a system through which report information may be verbally operated or used with voice activation to achieve a desired result. In this manner a great variety of information as may be provided to another or even captured for internal use. Such can be assembled and provided or captured through some use of voice information, be it voice command information or voice data information or otherwise.

In some embodiments, the information may be available to or from a computer controlled report paradigm, such as a system in which information and perhaps data is maintained or provided in some fixed arrangement. Such a paradigm of course may include a database or any other collection of information and may be established by prior or concurrent activity on a computer. It may alternatively or also be subjected to a computer command structure through which the data may be altered, analyzed, selected or otherwise used. In one embodiment, information may be generated or influenced by voice based information and to accomplish this there may be an automated voice based information entry interface that facilitates entry of some voice based information into the system for appropriate use.

Internally, a computer paradigm may be configured as appropriate such as a field manipulatable computer controlled report paradigm in which particular fields, columns, data tags, formatting, segmentation, arrangement, or other structure may be facilitated. When configured at least in part in a more traditional manner, such a paradigm may be considered a database configured computer controlled report paradigm. This may include spreadsheet data, a traditional database paradigm, a field based data paradigm, a tagged data paradigm, or most generically a computer controlled report paradigm (with report representing any indication or collection of some amount of information).

As mentioned above, the voice based information may act upon the system through some type of interface. This interface may be activated or provided as one particularly appropriate to voice based information such as telephony, telephone service, cellular service, voice over IP, web based voice services, or the like. This interface may act to accept voice based data, such as data contained in a voice format from a user such as the person using the cell phone or the like. In some embodiments, it may thus be configured as establishing a telephone service information entry interface or perhaps establishing a cellular service information entry interface. Once through the interface, the voice based information may be accepted by the system such as by including hardware, software, firmware, or the like to act with some degree of automation perhaps full automation or perhaps partial. Such a system may also include a voice based information acceptance element similar to that discussed earlier.

As a result of or responsive to (whether direct or indirect) such elements, the system may utilize the voice based information input to it to automatically act to computer manipulate the appropriate data or, more broadly, paradigm.

Manipulation of any aspect of the computer controlled report paradigm may occur and is intended to be included whether it be data entry, data reordering, mathematical data operations, format changing, outputting, or any other type of activity. Further, in some embodiments, the manipulation may occur with some or total automation and thus there may be considered to be an automatic computer manipulation element.

In embodiments configured for report information applications, after or because of some voice based information, the system may computer generate some desired report information. This information may be influenced in some manner by and may be responsive to the voice based information. This generated report may be provided to the inputting user, to another user, or even to a collected group of users as may even be specified by the voice based information. The system may be considered to have a computer report information generator that is influenced by the voice based information.

In some embodiments, the system may act to present data report information, such as information that includes data of some sort. It may also present information of a voice character such as presenting voice information either alone or in conjunction with a textual or character based presentation. It may even retain the voice based information as a check to verify accuracy if desired. In providing a report of some type, it may act to access stored voice information. It may also accomplish word recognition of the voice based information. This may include converting the voice based information to character based information. Both types of information may be stored and alone or simultaneously available to a user, of course.

Apart from a data entry method where an input of new data may be accomplished, the system may permit the voice based information to act as entered command information. In this manner the user entering voice based information may cause an appropriate command to be automatically accomplished (e.g. “E-mail my expense report to John.”). Such commands may include but not be limited to items such as providing information to at least one person designated by a user, providing a specified portion or information to a person or persons, or other actions.

To facilitate ease of using the system, it may be customizable by or for a user such as that a repetitive task or the like may be accomplished in a more easy fashion (e.g. “expense report”<pause> “31^{st}” <pause> “$42.21” <pause> “travel” <pause> “New York” <pause> “distribute”). This may include using verbal or even separate keystroke based instructions or other indications (such as pauses) to permit the user to specify a customizable data input sequence, a user customizable data output sequence, verbally select particular reporting functions, or the like. Functions that may be accomplished by voice based information may include operations including but not limited to: sorting, setting field information, prompting entry, sequencing entry, outputting data, outputting data from the computer controlled report paradigm in a voice specified sequence, specifying an automatic distribution operation, specifying an automatic email distribution list, specifying management report information actions, scheduling an item such as a report information, or the like. With respect to the broad variety of actions encompassed and possible, the actions may involve one or more users, such as a first user (who may input voice based information) and a second user (who may receive information as a result of the actions of the first user.

Another embodiment may be as a system through which composite activities may be accomplished as a result of a voice based information input. In this manner by perhaps a remote voice input, different actions as may be desired may be accomplished. These may even involve automated direction to outside service providers at yet another location or the like. This remote location may be merely physically separated or perhaps on the other side of the world from the location at which the computer acts.

In some embodiments, the system may make voice based information available to a computer in a manner that serves to verbally instruct one or especially more computer actions. This may occur without substantial human intervention such as when only minor tasks (e.g. placing an item in an envelop and mailing it or the like) are accomplished by human action, or it may occur in a completely automated manner.

In such a system, as before, there may be an input and an information entry interface. Information in an embodiment may also include multistructured voice based information such as information that is not only voice based, but that is appropriate to accomplish a variety of structured tasks. These tasks may include automatically tiered commands and may direct disparate computer activities such as activities that are not usually considered to be linked to or required by one another (e.g., entering information and collating a report or the like). With appropriate configuration, the system may establish hardware, software, firmware or the like to serve as a multistructured voice based information acceptance element such as where this type of information is successfully accepted into the system. As mentioned, the multistructured voice based information may include verbal instructions to a computer. It may also include tiered commands such as when one step is accomplished after another, or such as when two different steps are accomplished but perhaps in any order. As mentioned, these steps may be disparate computer activities and they may even be directed by a multicomponent command such as a single item of voice based information that directs all aspects of the disparate computer activities. The system may even serve to automatically establish sequential commands, cause automatically tiered commands, cause two unrelated operations, and perhaps cause two functionally unrelated operations as a result of either a voice based information input or perhaps even a multicomponent command. In instances where an embodiment acts remotely, it may be considered as having a remote automatic tiered command disparate action computer activation element or perhaps even an automatic tiered command computer output element. Output from an embodiment may be automatically generated in response to the voice based information such as when an embodiment automatically computer generates an output as and if commanded. When an input operation is achieved at a remote location, the output may similarly be considered to be remote.

Further to facilitate user involvement, as before, embodiments may be configured to permit and perhaps create a user customizable input operation as well as a user customizable output operation or even a user customizable data operation. Beyond the customizable options, there may also be configuration to accommodate an output operation from yet another remote location and even a data entry operation at another remote location. This may include items such as automatically commanding a document handling action at either the computer remote location or at some other location. Of particular interest may be the aspect of instructing a separate service provider (such as Kinko's™ or some other document handling service) to take an action at a different remote location all as a result of one or more voice based information inputs, perhaps by a cell phone or the like perhaps on the other side of the world. Thus the disparate computer activities may be quite varied and may include but not be limited to items such as attaching documents or computer file(s), altering documents or computer file(s), emailing documents or computer file(s), saving computer file(s), naming computer file(s), computer printing items, faxing items, attaching a voice, picture, .wav, .mp3, .jpg, .tif, .gif, spreadsheet, .xls, word processing, .doc, image, or perhaps a .pdf computer file, entering data or the like.

Embodiments may include a method of offering services, and embodiments may include a method of offering retail services or even advertising. Advertising may include any mechanism through which a consumer may be made aware of the services of a vendor. Some such embodiments may include defining a field of services. Such a field of services may be understood to include a number of services which may be related by any suitable characteristic to which said services may be directed or may otherwise be considered appropriate for some presentation.

Certain embodiments may include identifying at least two vendors capable of providing such services. A vendor may be understood to include any entity capable of providing a good or a service. Identifying at least two vendors may be understood to include any suitable selection of such vendors as may be appropriate for a given circumstance. In certain embodiments, vendors may be commercial retailers.

Some embodiments may include user identifying vendors, which may be understood to include a user making an affirmative selection of a vendor. Certain embodiments may include presetting vendors, which may be understood to include providing preselected vendors to a user, from which a user may make a selection.

Various embodiments may include identifying at least one third-party vendor capable of providing services in a defined field of services. The term third-party vendor may be understood to include vendors not affiliated with a service provider of an automated fulfillment protocol such as a sequence for ordering goods or services or the like. This may permit a service provider of an automated fulfillment protocol to selectively include a third-party vendor in such an automated fulfillment protocol in exchange for value, and specifically may even avoid the situation of a vendor selectively including itself within an automated fulfillment protocol.

Various embodiments may include ascertaining conditions necessary to complete a transaction with a vendor. Such conditions necessary to complete a transaction may include any condition necessary to bring a transaction with a vendor to a desired conclusion. In some embodiments, a transaction may include a purchasing transaction, and ascertaining conditions necessary to complete such a purchasing transaction may include ascertaining conditions such as product type information, product availability information, quantity information, pricing information, delivery information, payment information, or perhaps other kinds of information attendant to a purchasing or other transaction.

Some embodiments may include providing an automated fulfillment protocol capable of satisfying conditions necessary to complete a transaction with a vendor. Such a fulfillment protocol may be understood to include processing capable of being implemented so as to complete a transaction with a vendor. For example, a fulfillment protocol may include identifying a particular good or service, tendering payment for such a good or service, and accepting or directing delivery of such good or service. However, it may be appreciated that a great variety of fulfillment protocols may be available depending on the needs of any particular transaction.

Moreover, the term automated may be understood to include a capability to engage in substantially self-directed action, perhaps self-directed action as may be possible without human significant intervention, and perhaps as may be typified by computer-implemented actions or existing on-line purchases. Accordingly, embodiments of an automated fulfillment protocol may include a computer implemented fulfillment protocol.

In various embodiments, a fulfillment protocol may be expressed in a variety of modalities. The term modality may be understood to include the mode by which information may be expressed. Examples of modalities may include voice, text, email, or code. Accordingly, embodiments may include a voice based fulfillment protocol, a text based fulfillment protocol, an email based fulfillment protocol, a code based fulfillment protocol, or a fulfillment protocol expressed in any modality suitable for interaction with a user of such fulfillment protocol. It may be appreciated that the modality through which a fulfillment protocol may be expressed may be tailored to meet the specific needs of a user, a given interface, or the like.

In some embodiments, a fulfillment protocol may include providing a user prompt. A user prompt may be understood to include prompting a user for some kind of information. Accordingly, in the context of a fulfillment protocol, a user prompt may be provided to prompt a user for information relevant to completing the fulfillment protocol.

In some embodiments, a fulfillment protocol may be menu driven. The term menu driven may be understood to include structuring information in a menu format. Accordingly, in the context of a fulfillment protocol, such a fulfillment protocol may be structured in a menu format. Moreover, such a menu driven structure may be expressed in a variety of modalities, including perhaps voice based, text based, email based, or code based.

In various embodiments, actions such as a fulfillment protocol or otherwise may be implemented through a voice capable communications device. This may allow, for example, a user of a fulfillment protocol to complete the fulfillment protocol via a voice capable communications device perhaps such as a cell phone.

Various embodiments may include automatically communicating such an automated fulfillment protocol via a voice capable communications device. A voice capable communications device may be any device capable of communicating in a voice modality. Example may include telephones, cellular phones, voice over IP, web services or the like, but it may be appreciated that a great variety of voice capable communications devices may exist depending on the specific circumstance or technologies evolving. The term communicating may be understood to include manifesting information in a manner capable of being directly or indirectly understood by a recipient of such information. Accordingly, embodiments may involve automatically communicating such an automated fulfillment protocol or the like via telephone service or perhaps cellular service. Moreover, it may be appreciated that such communication may be by way of any appropriate modality, including perhaps voice, text, email, code, or other suitable modality.

Certain embodiments may include automatically accepting user input through a voice capable communications device in response to said automated fulfillment protocol. In this context, the term accepting may be understood to involve any action by which user input may be processed by a voice capable communications device. As applied to voice, user input may be understood to include any information able to be entered by a user into or by, or most broadly, via a voice capable communications device. By responding to an automated fulfillment protocol, it may be understood that a user may enter information responsive to a process defined by such an automated fulfillment protocol. Accordingly, embodiments may involve automatically accepting user input via telephone service or perhaps cellular service or otherwise. Moreover, it may be appreciated that such user input may be by way of any appropriate modality, including perhaps voice, text, email, code, or other suitable modality.

Certain embodiments may include ascertaining conditions necessary to complete a transaction with such a third party vendor. In some embodiments, a transaction may be a purchasing transaction. A purchasing transaction may be a transaction with a vendor whereby a good or service is obtained through the vendor. Various embodiments may include providing an automated fulfillment protocol capable of satisfying such conditions necessary to complete a transaction with such a third-party vendor. Some embodiments may involve selectively enabling inclusion of a third-party vendor within an automated fulfillment protocol. The term selectively enabling inclusion may be understood to encompass but not be limited to inclusion of a third party vendor within an automated fulfillment protocol on a selective basis. Such a selective basis may include any number of criteria that may be appropriate. For example, embodiments may involve including a third-party vendor in exchange for some form of value, perhaps including monetarily quantifiable value such as a fee or payment arrangement. In this manner, it may be seen that whereas a third-party vendor may desire to be included within a fulfillment protocol so as to have an outlet to consumers for its services, so may the service provider of a fulfillment protocol have a capability to profit from provision of the fulfillment protocol by being selective in the inclusion of such third-party vendors and thus providing advertising.

Certain embodiments may include automatically responding to a user triggered retail activity related to a field of service (including goods, of course). A retail activity may be understood to include any activity directed toward providing or consuming retail goods or services. A user triggered retail activity may be understood to include initiation of retail activity by a user, for example as by a user providing an indication of a retail need. Such a user provided indicator of a retail need may include, for example, voice information, text information, email information, code information, or other information, such as may be provided by a user indicating a need for retail services (to provides goods or services). The term automatically responding to a user triggered retail activity may be understood to include generating a responsive action to such a user triggered retail activity, for example, by detecting a user provided indicator of a retail need or opportunity. In various embodiments, such detecting may involve detecting user provided voice information, text information, email information, code information, or other information, and ascertaining that such information may relate to a retail opportunity involving of such a user. Moreover, such detecting in various embodiments may involve doing so via telephone services, or perhaps by cellular services, or the like.

Embodiments may involve an event notification method. The term event notification may be understood to include an ability to notify a recipient of an event. The term event may be understood to include an occurrence, perhaps even an occurrence, having a day or days of occurrence, or even having a definite or approximate starting time.

Various embodiments may involve establishing an automated voice capable event calendaring interface. An event calendaring interface may be understood to include an interface through which calendar data related to an event may be entered.

Some embodiments may include providing at least one voice based calendar parameter identifier. A voice based calendar parameter may be understood to include a parameter of calendar information presented in voice format. Examples of such a calendar parameter may perhaps include a subset of such calendar information, as perhaps a sentence, word, or even phoneme in a voice based message relating to calendar information. Examples of a calendar parameter may further include separately articulated calendar information, for example calendar information which perhaps may not be included in an original voice based message but may perhaps be separately vocalized and appended to or associated with such original voice based message. A calendar parameter identifier may be understood to include an element of a voice capable event calendaring interface capable of identifying a calendar parameter of voice based information.

Certain embodiments may include accepting event calendar data through an automated voice capable event calendaring interface. Event calendar data may be understood to include calendar data related to an event, and calendar data may be understood to include data typically used in calendaring, such a date, time, action, or the like. In this context, the term accepting may be understood to involve any action by which event calendar data may be successfully processed by an automated voice capable event calendaring interface. Moreover, in certain embodiments, an automated voice capable event calendaring interface may include an automated voice capable communications device accessible event calendaring interface. This may be understood to include an automated voice capable event calendaring interface which may accessed by a voice capable communications device. Accordingly, it may be appreciated that accepting event calendar data may be via telephone services, or perhaps even cellular services or the like.

Some embodiments may include automatically assigning at least one voice based calendar parameter to said event calendar data. In this context, the term assigning may be understood to include any action by which a voice based calendar parameter may be associated with event calendar data.

Various embodiments may include selecting a reminder time keyed to an event. A reminder time may be any time capable of reminding a recipient of the occurrence of such an event, the term keyed may be understood to include scheduled at any time meaningfully related to the occurrence of such an event, for example perhaps as in advance of such an event.

Certain embodiments may include automatically transmitting a voice based calendar parameter at a reminder time to a user via a voice capable communications device. The term transmitting may be understood to include communicating information from one location to another location, perhaps as a reminder time stored on a computer may be communicated to a voice capable communications device.

Some embodiments may include establishing an automated voice capable communications device accessible event calendaring interface. This may be understood to include an automated event calendaring interface which may be accessible by a voice capable communications device. Accordingly, embodiments may include establishing an automated telephone accessible event calendaring interface. Moreover, the term automated may be understood to include a capability to engage in substantially self-directed action, perhaps self-directed action as may be possible without significant human intervention, and perhaps as may be typified by computer-implemented action. Accordingly, embodiments may include establishing a computer implemented voice capable communications device accessible event calendaring interface.

Various embodiments may include accepting event calendar data through an automated voice capable communications device accessible event calendaring interface. In this context, the term accepting may be understood to involve any action by which event calendar data may be processed by an automated voice capable communications device accessible event calendaring interface.

Some embodiments may include remotely accessing event calendar data through a voice capable communications device on a selective basis. The term remotely accessing may be understood to include accessing event calendar data from a location that is remote from the location of such event calendar data. Accordingly, for embodiments including an automated voice capable communications device accessible event calendaring interface, it may be appreciated that remotely accessing may include accessing via telephone service or perhaps even cellular service or the like, and through any appropriate modality enabled by such telephone service or cellular service, including perhaps voice, text, email, or code. The term selective basis may be understood to include selecting specific event calendar data to access. Examples of a selective basis may include accessing event calendar data on a scheduled time basis (which may be understood to include times at which events may be scheduled), on an event specific basis (which may be understood to include selecting events and receiving information about their scheduled times), or any other basis upon which it may be possible to particularly select calendar data.

A number of aspects of the inventive technology may combine with one or more other embodiments of the invention. While these aspects may be described in terms relevant to a specific embodiment, it should be appreciated that such aspects perhaps may be functionally relevant to a number of embodiments and therefore should be understood to be included in all such embodiments to which such aspects may be functionally relevant.

Information in various embodiments may be modality based. The term modality may be understood to include the mode by which information may be expressed. Examples of such modalities may include voice, text, email, and code. The term code may be understood to include a communications system in which arbitrary representations, such as words, sounds, symbols, data, or the like, are assigned definite meanings. In various embodiments, information may be accepted or transmitted. In this context, accepting may include simply receiving (and perhaps even rejecting) information by any technique through which such information may be received. The term transmitted may be understood to include moving or providing information from one location to another location. In various embodiments, accepting or transmitting information may be accomplished via telephone services, which may include telephony, telephone service, cellular service, voice over internet protocol, web based service, or any other service avenue the implementation of which may involve a telephone.

Various embodiments may involve the use of information parameters. Such information parameters may be understood to include voice based parameters, subject based parameters, calendar parameters, and any other parameters coordinated to a specific type of information or application.

In various embodiments, an information entry interface may perhaps include a computer linked voice mail system. The term computer linked voice mail system may be understood to include a voice mail system capable of interacting with a computer, for example perhaps as exhibiting increased functionality by access to the capabilities of such a computer.

Some embodiments may involve automatically discerning a characteristic. Such a characteristic may be understood to include characteristics such as a voice based characteristic, a subject based characteristic, or a calendar based characteristic. Such characteristics may be understood to include information that is representative of the items they characterize, for example, voice information of a message, subject information of a message, or calendar information of a message. The term automatically discerning may be understood to include isolating specific information contained within a larger set of information and perhaps separating such isolated information as a separate item or otherwise determining the item. Examples of automatically discerning may include word recognition, key stroke recognition, data tagging, or any other technique for isolating information as described.

Certain embodiments may include providing a separate data entry field. The term separate data entry field may be understood to include a field for entering data related to certain information but kept segregated from such information to which the field may relate. A separate data entry field may include fields for entering data of a general nature, or may be specific to the information to which the field relates. For example, a voice based data entry field may contain voice information related to an item, such as voice message, a subject based data entry field may contain subject information related to a voice message (for example perhaps a subject line information field), and a calendar data entry field may contain calendar information related to an item, such as a voice message (for example perhaps a calendar line information field).

Moreover, it may be appreciated that a separate voice based data entry field may contain a variety of kinds of information in a voice modality, including perhaps subject information related to a voice message, date information related to a voice message, or sender information related to a voice message. In some embodiments, a separate voice based data entry field even may be a subject line information field for a voice based message. It may even be possible for a separate voice based data entry field to be time limited, for example so as to limit the duration of voice data which may be entered into the field. Various embodiments may include allowing such a field to be user set time limited, which may allow a user of such a field to set the duration of the time limit.

Various embodiments may include providing a user prompt. A user prompt may be understood to include prompting a user for some kind of information. For example, providing a user prompt perhaps may include requesting a subject line, or perhaps may include requesting a calendar line.

In certain embodiments, parameter identifiers may be menu driven. The term menu driven may be understood to include structuring information in a menu format. Various types of parameter identifiers may be menu driven, including perhaps voice based parameter identifiers, subject based parameter identifiers, calendar parameter identifiers or the like. In some embodiments, a menu driven subject based parameter identifier may be voice based, text based, email based, or code based.

Various embodiments may involve computer assigning information, for example perhaps computer assigning an information parameter. The term computer assigning may be understood to include using a computer to accomplish the act of assigning. In various embodiments, such computer assigning may include creating a data association among related pieces of information, for example perhaps among an information parameter and the information to which the parameter identifier pertains. Such a data association may be understood to include keeping such two types of information associated, for example perhaps as to be able to recover and use such data at a future time in an associated manner.

Certain embodiments may involve user receiving various kinds of information parameters. The term user receiving may be understood to include reception of such information parameters by a user of such information parameters. In various embodiments, user receiving may include receiving by telephone service, cellular service, or perhaps any technique by which such an information parameter may be received by a user.

Some embodiments may include user receiving multiple information parameters, including perhaps multiple voice based parameters. Such multiple information parameters should be understood to include items generated by multiple parameter identifiers for a single message, or perhaps multiple parameter identifiers from multiple messages. Various embodiments may permit a user to sort such multiple information parameters, navigate through such multiple information parameters, and perhaps selectively utilize such multiple information parameters. Such selective use of such multiple information parameters may include for example, skipping less desirable information parameters and monitoring more desirable information parameters.

Various embodiments may include user evaluating information, for example perhaps user evaluating an information parameter. The term user evaluating may be understood to include a user examining such information based on one or more criteria which the user may apply. For example, user evaluating may include user determining a need to review message information, for example perhaps voice based message information, based on evaluating an information parameter associated with such voice based information (e.g. the subject line for a voice message). In some embodiments, user evaluating may involve evaluating subject line information which may be facilitated by system configuration.

Various embodiments may involve defining an event, automatically calendaring a reminder time keyed to said event, and automatically transmitting a reminder message to a user at said reminder time. The term calendaring may be understood to include storing calendar data, perhaps including date and time data, perhaps for retrieval and use of such calendar data at a later date. A reminder time may be any time capable of reminding a recipient of the occurrence of such an event, the term keyed may be understood to include scheduled at any time meaningfully related to the occurrence of such an event, for example perhaps as in advance of such an event. The term transmitting may be understood to include communicating information from location to another location, perhaps as a reminder time stored on a computer may be communicated to a voice capable communications device. A reminder message may be understood to include any message containing reminder time information.

Accordingly, it may be appreciated that automatically transmitting a reminder message may involve transmitting via telephone service, or perhaps cellular service. Moreover, it may be appreciated that a reminder message may be transmitted in any suitable modality, for example including voice, text, email, code, or other suitable modality. Some embodiments may involve automatically transmitting a user generated voice reminder message, which may be understood to include reminder messages in the user's own voice, for example as where a user may prerecord a reminder in his or her own voice, store the reminder, and receive the reminder at a subsequent reminder time on his or her cell phone, as but one example.

In the context of reminder messages, some embodiments may involve defining an event, wherein the event may be service appropriate. The term service appropriate may be understood to include an event for which retaining, engaging, or considering services may be desirable. Examples of services appropriate events may include birthdays, anniversaries, business meetings, and the like. In this manner, it may be appreciated that a reminder message may alert a user to services (such as retail services to provide goods or services or the like) that may be relevant to the event described in the reminder. Certain embodiments may even include various avenues to permit such a user to engage in retail activity, including perhaps as may otherwise be described herein.

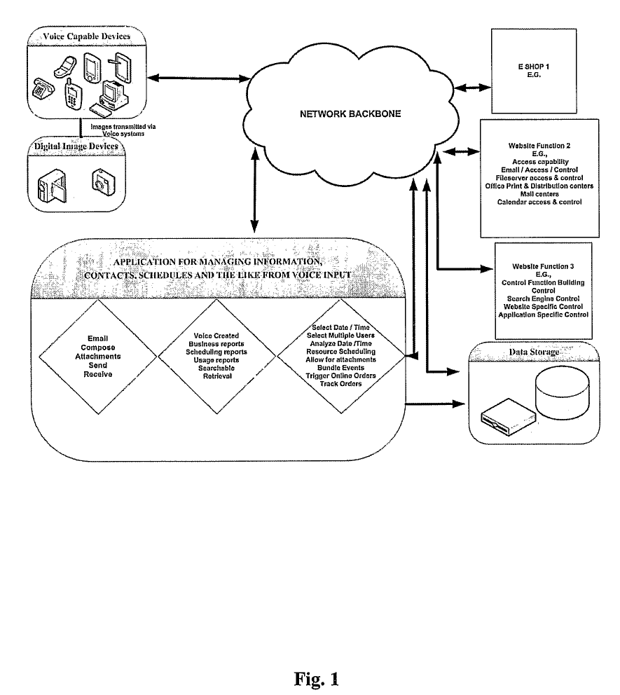

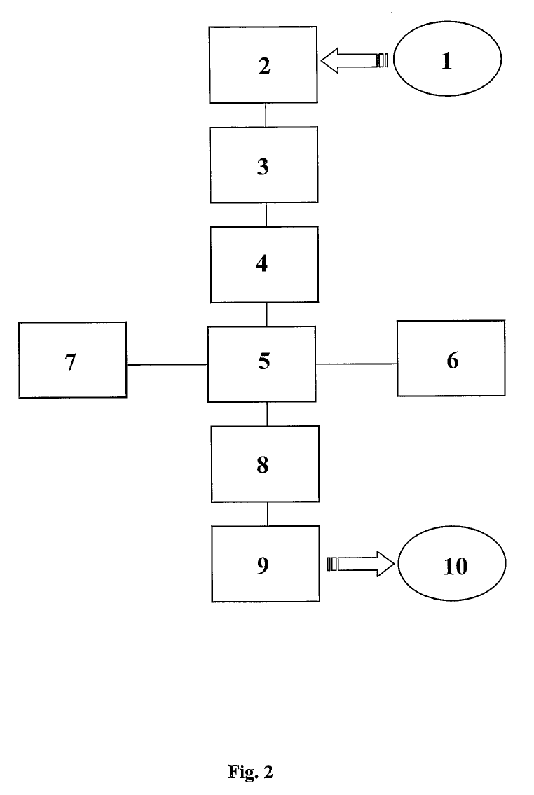

While the invention is perhaps best understood by reference to the methods and actions to be taken, an understanding of a general hardware configurations may put aspects in a more tangible context. The following discussion is set forth in very general terms with multiple embodiments interspersed. Accordingly, familiarity with the overall methods described above may be helpful or even necessary to putting the various hardware or software apparatuses in perspective. Particularly referring to FIG. 2, a general or generic hardware or software configuration of some embodiments, it can be understood that this figure indicates general elements as may be used, varied, included, or perhaps even not applied in any specific embodiment. For this reason, it should be understood that this figure is illustrative only and is used to indicate a wide variety of elements in one figure. In some embodiments, specific boxes may not exist or may be configured or connected in other ways. With this understanding, FIG. 1 illustrates an initial input such through as a voice capable communications device (1). In this fashion, a user or, in some embodiments, a consumer may input some aspect to the system. Depending upon how the particular embodiment is configured, whether as a voice based message information system, a voice based retail system, a voice based event notification system, or otherwise, the input may be a command or instruction, an item of data (whether values or voice or even a file), or any other input. Once provided, this input may be passed to the system through some interface or interface element (2). Depending on the embodiment configuration, the interface element (2) may serve as an automated voice based information entry interface through which voice based information (such as when information is contained in voice form) is provided, an automated voice capable information entry interface such as an interface capable of accepting voice in a somewhat automated manner, a voice capable event calendar interface, an automated voice capable communications device accessible event calendar interface such as an interface that is configured at some level to deal with calendared events, an automated voice capable communications device accessible event calendar interface, or any other interface. Once provided, the input can be accepted by some type of acceptance element (3). Again, depending on the configuration, this element may be a voice based message acceptance element such as can accept voice based information, an event calendar data acceptance element such as can accept calendar related items, or any other acceptance element (3). As can be understood, such acceptance elements may be responsive (such that an action directly or indirectly—even if through intervening elements could cause some change or otherwise affect the element) to the interface element (2).

In particular embodiments, various functions can occur and thus various elements can be considered as shown. For example, in embodiments there may be included a voice based parameter identification element (shown conceptually as (4)) such as software, firmware, subroutines, data, hardware components, or the like that may act to identify, tag or otherwise delineate a parameter that is specified by voice based information. In some embodiments, the activity may be accomplished by a subject based parameter identification element (4) that identifies or otherwise delineates some subject character of the related item (such as a voice message or the like). In other embodiments, activities may indicate that this schematic box (4) may be best described as indicating a field of service definition element (4) such as software, firmware, subroutines, data, hardware components, or the like that may define a particular field of service (as may be appropriate in a retail system discussed above, an event definition element that sets or indicates a character of an event in some manner, or the like.

Additional actions, such as an at least two vendor identification element (5) that may aid in indicating at least two vendors appropriate perhaps to a field of service, a voice based calendar parameter identifier element (5) such as might identify a calendar related item that is indicated by or through voice based information, or the like may be shown as appropriate. This may even serve as or be responsive to a third-party vendor identification element (6) such as software, firmware, subroutines, data, hardware components, or the like through which outside third parties may be selected and identified as appropriate to a given circumstance or even a third-party vendor inclusion element (6) such as includes third party vendors as a result of advertising payments, criterion satisfaction, or the like. Again, all of these may be responsive to one or more of the others so that a change in one may being about some alteration directly or indirectly in another.

Other actions may also be accomplished ancillary to or as inputs or output with a particular other action. For example, in some embodiments, there may be a completion condition ascertainment element (7) such as determines if establishment of a set condition or the like is accomplished. Included in or separate from such an embodiment may be other action elements such as an automated fulfillment protocol element (7) such as may provide a fulfillment protocol that satisfies conditions needed to adequately establish criteria that permit another event to take place (such as a purchase or the like). In embodiments requiring, there may be a transaction completion condition ascertainment element (7) such as may make the previously mentioned determination as well. (Again, one box in the figure is used to indicate what may be a separate element in a particular configuration.)

Some embodiments may include an automated user triggered retail activity response element (8) such as may use an indication of some possible retail activity (whether providing or offering or merely advertising goods or services) and may even permit a response to actually consummate or simplify a particular transaction. In this or other embodiments there may be included a reminder time keyed selection element (6) such as may cause or permit selection of a particular item or set of items to occur as may be appropriate to an associated time or calendar event. This may be responsive to an automatic voice based calendar parameter assignment element (8) such as may use automation to assign voice based information as a parameter somehow associated with a calendar item. If appropriate, an automatic voice based calendar parameter transmission element (9) or the like may act in response to an appropriate activity or item of information in a manner such as might transmit an appropriate parameter and its information in a desired form to another element or even to some person. Similarly, in other or such embodiments, the schematic may also be characterized as indicating a computer report information generator (9) that may assemble or otherwise provide report appropriate information as a more ending action. This may result in an output to a person or other system (10) at yet some other location.

Referring back to intermediate activities in some embodiments, embodiments of the system may include an automated voice based parameter assignment element (7) such as may assign an item of voice based information as a parameter (whether a synopsis or otherwise) or an item of fielded or other information appropriate to an associated input such as a message or the like. In instances in which the parameter is a subject line or other synopsis information from which pertinence or other aspects may be determined, this may also represent an automated subject based parameter assignment element (7). When the system serves as a voice integrated calendar or the like, this may conceptually indicate an automatic voice based calendar parameter assignment element (7).

Other ancillary or integral functions may also be included such as the inclusion of one or more storage elements (perhaps indicated conceptually as box (8). This may include configuration to serve as an automated voice based message storage element (8) such as may store all or a significant part of a voice based message, or even an automated voice based parameter storage element (8) such as may store a separate item or even a chosen portion of an entire voice based message. For some embodiments, this may also represent an automated subject based parameter storage element (8) such as may contain the subject information referred to above.

The discussion included in this application is intended to serve as a basic description. The reader should be aware that the specific discussion may not explicitly describe all embodiments possible; many alternatives are implicit. It also may not fully explicitly explain either the generic or specific nature of the invention and may not explicitly show how each feature or element can actually be representative of a broader function or of a great variety of alternative or equivalent elements. Again, these are implicitly included in this disclosure. Where the invention is described in method-oriented terminology, each step of the process implicitly may be performed by an element. Apparatus claims may not only be included for the methods described, but also method or process claims may be included to address the functions each element performs. Neither the description nor the terminology is intended to limit the scope of the claims that will be included in any subsequent patent application. For instance, the claims are directed to both methods and apparatus. Although the methods related to the system have been included in various detail, only initial claims directed toward the apparatus aspects of the system have been included. The disclosure of methods is sufficient to support the full scope of apparatus claims as well. While these may be added later to explicitly include such details, the existing claims should be construed to encompass and support such aspects. Thus, without limitation, the present disclosure should also be construed to encompass apparatus subclaims and dependent claims similar to those presented in a method context.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of an “interface” should be understood to encompass disclosure of the act of “interfacing”—whether explicitly discussed or not—and, conversely, disclosure of the act of “interfacing”, should be understood to encompass disclosure of an “interface element” and even a “means for interfacing.” Such changes and alternative terms are to be understood to be explicitly included in the description.

Any patents, publications, or other references mentioned or listed in this patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of references are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

I. U.S. PATENT DOCUMENTS

| DOCUMENT NO. | | |
|---|---|---|
| & KIND CODE (if | PUB'N DATE | PATENTEE OR |
| known) | mm-dd-yyyy | APPLICANT NAME |
| 2004/0267574 | 12/30/2004 | Stefanchik et al. |
| 2002/0099534 | 07/25/2002 | Hegarty |
| 2003/0046073 | 03/06/2003 | Mori et al. |
| 5,689,585 | 11/18/1997 | Bloomberg et al. |
| 5,704,371 | 01/06/1998 | Shepard |
| 5,822,544 | 10/13/1998 | Chaco et al. |
| 6,026,363 | 02/15/2000 | Shepard |
| 6,131,032 | 10/10/2000 | Patel |
| 6,172,948 B1 | 01/09/2001 | Keller et al. |
| 6,272,461 B1 | 08/07/2001 | Meredith et al. |
| 6,272,575 B1 | 08/07/2001 | Rajchel |
| 6,362,409 B1 | 03/26/2002 | Gadre |
| 6,405,195 B1 | 06/11/2002 | Ahlberg |
| 6,556,973 B1 | 04/29/2003 | Lewin |
| 6,611,846 B1 | 08/26/2003 | Stoodley |
| 6,615,350 B1 | 09/02/2003 | Schell et al. |
| 6,766,328 B1 | 07/20/2004 | Stefanchik et al. |

II. FOREIGN PATENT DOCUMENTS

| Foreign Patent Document | | |
|---|---|---|
| Country Code, Number, Kind | PUB'N DATE | PATENTEE OR |
| Code (if known) | mm-dd-yyyy | APPLICANT NAME |
| WO 02/46886 A2 | 06/13/2002 | Antaeus Healthcom.Inc. |
| | | d/b/a |
| | | Ascriptus, Inc. |

III. OTHER DOCUMENTS

Admiral Online DictoMail Voicemail to Text Translation Technology, Press Release Newswire,
Feb. 02, 2005
Admiral Online DictoMail Voicemail to Text Messaging, printed webpages Jan. 31, 2006, 4 pages
Metaphor Solutions Speech IVR Home Page, printed webpages Jan. 31, 2006, 2 pages
United States Provisional Application Number 60/649,719, Filed 02 Feb. 2005, 16 pages, 1
drawing
www.spinvox.com/services/index.php; Services; 2 pages
www.spinvox.com/services/features.php; What Can SpinVox Do?; 2 pages
www.spinvox.com/services/business.php; Business Users; 2 pages
www.spinvox.com/article.php?id=35; Setting up SpinVox - FAQs; 3 pages
www.spinvox.com/news/index.php; SpinVox - Latest SpinVox Updates; 5 pages
www.spinvox.com; Converting Voicemail to Mobile Phone Texts - Free Trial; 2 pages
www.spinvox.com; SpinVox - Services; 4 pages
www.metaphorsol.com; Metaphor Solutions Speech IVR Home Page; 2 pages
www.metaphorsol.com/company/index.htm; Metaphor Solutions Company Description; 1 page
www.metaphorsol.com/solutions/customer_service_applications; 2 pages
www.metaphorsol.com/solutions/speechoutlook.htm; Metaphor Solutions SpeechOutlook; 8 pages
www.metaphorsol.com/solutions/customer_service_demo.htm; Metaphor Solutions Live Speech
Applications; 5 pages
www.metaphorsol.com/solutions/FAQ.htm; Metaphor Solutions Frequently Asked Questions; 5
pages
www.metaphorsol.com/solutions/enterprise.htm; Metaphor Solutions Enterprise Speech
Applications; 2 pages
www.metaphorsol.com/solutions/healthcare.htm; Metaphor Solutions Health Care Speech
Applications; 2 pages
www.metaphorsol.com/solutions/financial.htm; Financial Services Speech Applications; 2 pages
www.metaphorsol.com/solutions/retail.htm; Metaphor Retail Speech Applications; 2 pages

Thus, the applicant(s) should be understood to have support to claim and make a statement of invention to at least: i) each of the automated devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, and xii) each potentially dependent claim or concept as a dependency on each and every one of the independent or other dependent claims or concepts presented. In addition and as to computer aspects and each aspect amenable to programming or other electronic automation, the applicant(s) should be understood to have support to claim and make a statement of invention to at least: xiii) processes performed with the aid of or on a computer as described throughout the above discussion, xiv) a programmable apparatus as described throughout the above discussion, xv) a computer readable memory encoded with data to direct a computer comprising means or elements which function as described throughout the above discussion, xvi) a computer configured as herein disclosed and described, xvii) individual or combined subroutines and programs as herein disclosed and described, xviii) the related methods disclosed and described, xix) similar, equivalent, and even implicit variations of each of these systems and methods, xx) those alternative designs which accomplish each of the functions shown as are disclosed and described, xxi) those alternative designs and methods which accomplish each of the functions shown as are implicit to accomplish that which is disclosed and described, xxii) each feature, component, and step shown as separate and independent inventions, and xxiii) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is or will be used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A method of providing voice based message information comprising the steps of:
establishing an automated voice based information entry interface;
providing at least one voice based parameter identifier;
accepting at least one voice based message through said automated voice based information entry interface;
automatically assigning at least one voice based parameter to said voice based message; and
automatically storing said voice based message and said voice based parameter.

2. A method of providing voice based message information as described in claim 1, wherein said step of establishing an automated voice based information entry interface comprises the step of establishing a computer linked voice mail system.

3. A method of providing voice based message information as described in claim 1, wherein said step of providing at least one voice based parameter identifier comprises the step of automatically discerning a voice based characteristic.

4. A method of providing voice based message information as described in claim 3, wherein said step of automatically discerning a voice based characteristic comprises word recognition.

5. A method of providing voice based message information as described in claim 1, wherein said step of providing at least one voice based parameter identifier comprises the step providing a separate voice based data entry field.

6. A method of providing voice based message information as described in claim 5, wherein said step of providing a separate voice based data entry field comprises the step of providing a subject line information field.

7. A method of providing voice based message information as described in claim 5, wherein said step of providing a separate voice based data entry field comprises the step of providing voice based information selected from the group consisting of subject information, date information, and sender information.

8. A method of providing voice based message information as described in claim 5, wherein said step of providing a separate voice based data entry field comprises the step of providing a time limited separate voice based data entry field.

9. A method of providing voice based message information as described in claim 8, wherein said step of providing a time limited separate voice based data entry field comprises the step of providing a user set time limited separate voice based data entry field.

10. A method of providing voice based message information as described in claim 1, wherein said step of providing at least one voice based parameter identifier comprises the step of providing a user prompt.

11. A method of providing voice based message information as described in claim 10, wherein said step of providing a user prompt comprises the step of requesting a subject line.

12. A method of providing voice based message information as described in claim 1, wherein said step of providing at least one voice based parameter identifier comprises the step of providing at least one menu driven voice based parameter identifier.

13. A method of providing voice based message information as described in claim 1, wherein said step of accepting at least one voice based message comprises the step of accepting at least one voice based message via telephone service.

14. A method of providing voice based message information as described in claim 13, wherein said step of accepting at least one voice based message via telephone service comprises the step of accepting at least one voice based message via a service selected from a group consisting of telephony, a telephone service, a cellular service, a voice over IP service, and a web based voice service.

15. A method of providing voice based message information as described in claim 1, wherein said step of automatically assigning comprises the step of computer assigning.

16. A method of providing voice based message information as described in claim 1, wherein said step of automatically assigning comprises the step of creating a data association linking said at least one voice based message and said at least one voice based parameter.

17. A method of providing voice based message information as described in claim 1, wherein said step of automatically storing comprises the step of computer storing.

18. A method of providing voice based message information as described in claim 1, further comprising the step of user receiving said at least one voice based parameter.

19. A method of providing voice based message information as described in claim 18, wherein said step of user receiving said at least one voice based parameter comprises the step of user receiving said at least one voice based parameter via telephone service.

20. A method of providing voice based message information as described in claim 19, wherein said step of user receiving said at least one voice based parameter via telephone service comprises the step of user receiving said at least one voice based parameter via a service selected from a group consisting of telephony, a telephone service, a cellular service, a voice over IP service, and a web based voice service.

21. A method of providing voice based message information as described in claim 18, wherein said step of user receiving said at least one voice based parameter comprises the step of user receiving multiple voice based parameters.

22. A method of providing voice based message information as described in claim 21, further comprising the step of sorting said multiple voice based parameters.

23. A method of providing voice based message information as described in claim 21, further comprising the step of user navigating said multiple voice based parameters.

24. A method of providing voice based message information as described in claim 18, further comprising the step of user evaluating said at least one voice based parameter.

25. A method of providing voice based message information as described in claim 24, wherein said step of user evaluating said at least one voice based parameter comprises the step of user evaluating subject line information.

26. A method of providing voice based message information as described in claim 24, further comprising the step of user determining a need to review said voice based message based on said evaluation of said at least one voice based parameter.

27-53. (canceled)

54. A method of verbally operating report information comprising the steps of:
establishing a computer controlled report paradigm;
establishing an automated voice based information entry interface;
accepting voice based information from a user through said automated voice based information entry interface;
utilizing said voice based information to automatically computer manipulate at least one aspect of said computer controlled report paradigm;
computer generating report information that has been influenced in at least some manner by said voice based information, to a user.

55. A method of verbally operating report information as described in claim 54, further comprising presenting data report information that has been influenced in at least some manner by said voice based information, to a user.

56. A method of verbally operating report information as described in claim 54, wherein said step of presenting data report information that has been influenced in at least some manner by said voice based information, to a user comprises the step of presenting voice information to a user.

57. A method of verbally operating report information as described in claim 54, wherein said step of presenting voice information to a user comprises the step of accessing stored voice information accepted through said voice based information entry interface.

58. A method of verbally operating report information as described in claim 54, wherein said step of utilizing said voice based information to automatically computer manipulate at least one aspect of said computer controlled report paradigm comprises the step of accomplishing word recognition of said voice based information.

59. A method of verbally operating report information as described in claim 58, wherein said step of accomplishing word recognition of said voice based information comprises the step of converting said voice based information to character based information.

60. A method of verbally operating report information as described in claim 54, wherein said step of accepting voice based information from a user through said automated voice based information entry interface comprises the step of accepting command information from a user through said automated voice based information entry interface.

61. A method of verbally operating report information as described in claim 54, wherein said step of accepting command information from a user through said automated voice based information entry interface comprises the step of accepting command information to provide information to at least one third person designated by a user.

62. A method of verbally operating report information as described in claim 54, wherein said step of accepting command information from a user through said automated voice based information entry interface comprises the step of accepting command information to provide a specified portion of said report information to at least one third person designated by a user.

63. A method of verbally operating report information as described in claim 54, wherein said step of establishing an automated voice based information entry interface comprises the step of establishing an automated voice based information entry interface via telephone service.

64. A method of verbally operating report information as described in claim 54, wherein said step of establishing an automated voice based information entry interface comprises the step of establishing an automated voice based information entry interface via a service selected from a group consisting of telephony, a telephone service, a cellular service, a voice over IP service, and a web based voice service.

65. A method of verbally operating report information as described in claim 54, wherein said step of establishing a computer controlled report paradigm comprises the step of establishing a field manipulatable computer controlled report paradigm.

66. A method of verbally operating report information as described in claim 54, wherein said step of establishing a computer controlled report paradigm comprises the step of establishing a database configured computer controlled report paradigm.

67. A method of verbally operating report information as described in claim 54, wherein said step of establishing a database configured computer controlled report paradigm comprises the step of establishing a database configured computer controlled report paradigm selected from a group consisting of a spreadsheet data paradigm, a database paradigm, a field based data paradigm, and a tagged data paradigm.

68. A method of verbally operating report information as described in claim 54, wherein said step of utilizing said voice based information to automatically computer manipulate at least one aspect of said computer controlled report paradigm comprises the step of utilizing said voice based information to input data to said computer controlled report paradigm.

69. A method of verbally operating report information as described in claim 54, wherein said step of utilizing said voice based information to input data to said computer controlled report paradigm comprises the step of establishing a verbally instructed user customizable data input sequence through which said step of utilizing said voice based information to input data to said computer controlled report paradigm is accomplished.

70. A method of verbally operating report information as described in claim 54, wherein said step of utilizing said voice based information to automatically computer manipulate at least one aspect of said computer controlled report paradigm comprises the step of utilizing said voice based information to automatically computer manipulate at least one aspect of said computer controlled report paradigm by operations selected from a group consisting of sorting at least a portion of said computer controlled report paradigm, setting field information for at least a portion of said computer controlled report paradigm, prompting entry for at least a portion of said computer controlled report paradigm, and sequencing entry for at least a portion of said computer controlled report paradigm.

71. A method of verbally operating report information as described in claim 54, wherein said step of utilizing said voice based information to automatically computer manipulate at least one aspect of said computer controlled report paradigm comprises the step of utilizing said voice based information to output data from said computer controlled report paradigm.

72. A method of verbally operating report information as described in claim 54, wherein said step of utilizing said voice based information to output data from said computer controlled report paradigm comprises the step of utilizing said voice based information to output data from said computer controlled report paradigm in a voice specified sequence.

73. A method of verbally operating report information as described in claim 54, further comprising voice specifying an automatic distribution operation for said report information.

74. A method of verbally operating report information as described in claim 54, wherein said step of voice specifying an automatic distribution operation for said report information comprises the step of voice specifying an automatic email distribution list for said report information.

75. A method of verbally operating report information as described in claim 54, wherein said step of computer generating report information that has been influenced in at least some manner by said voice based information, to a user comprises the step of computer generating report information selected from a group consisting of expense report information, travel report information, management report information, and scheduling report information.

76. A method of verbally operating report information as described in claim 54, wherein said step of computer generating report information that has been influenced in at least some manner by said voice based information, to a user comprises the step of establishing a verbally instructed user customizable data output sequence through which said step of computer generating report information that has been influenced in at least some manner by said voice based information, to a user is accomplished.

77. A method of verbally operating report information as described in claim 54, wherein said step of establishing a verbally instructed user customizable data output sequence through which said step of computer generating report information that has been influenced in at least some manner by said voice based information, to a user is accomplished comprises the step of verbally selecting particular reporting functions to be accomplished as part of said step of computer generating report information that has been influenced in at least some manner by said voice based information, to a user.

78. A method of verbally operating report information as described in claim 54, wherein said step of accepting voice based information from a user through said automated voice based information entry interface comprises the step of accepting voice based information input from a first user through said automated voice based information entry interface, and further comprising the step of presenting data report information that has been influenced in at least some manner by said voice based information from said first user, to a second user.

79-163. (canceled)

164. An event notification method comprising the steps of:
establishing an automated voice capable event calendaring interface;
providing at least one voice based calendar parameter identifier;
accepting event calendar data through said automated voice capable event calendaring interface;
automatically assigning at least one voice based calendar parameter to said event calendar data;
selecting a reminder time keyed to said event; and
automatically transmitting said voice based calendar parameter at said reminder time to a user via a voice capable communications device.

165. An event notification method as described in claim 164, wherein said step of establishing an automated voice capable event calendaring interface comprises the step of establishing a computer linked voice mail system.

166. An event notification method as described in claim 164, wherein said step of providing at least one voice based calendar parameter identifier comprises the step of automatically discerning a calendar based characteristic of said at event calendar data.

167. An event notification method as described in claim 166, wherein said step of automatically discerning a calendar based characteristic comprises using a technique for automatically discerning selected from the group consisting of word recognition, key stroke recognition, and data tagging.

168. An event notification method as described in claim 164, wherein said step of providing at least one voice based calendar parameter identifier comprises the step providing a separate voice based calendar data entry field.

169. An event notification method as described in claim 168, wherein said step of providing a separate voice based calendar data entry field comprises the step of providing a calendar line information field.

170. An event notification method as described in claim 164, wherein said step of providing at least one voice based calendar parameter identifier comprises the step of providing a user prompt.

171. An event notification method as described in claim 170, wherein said step of providing a user prompt comprises the step of requesting a calendar line.

172. An event notification method as described in claim 164, wherein said step of providing at least one voice based calendar parameter identifier comprises the step of providing at least one menu driven voice based calendar parameter identifier.

173. An event notification method as described in claim 164, wherein said step of accepting event calendar data comprises the step of accepting event calendar data via telephone service.

174. An event notification method as described in claim 173, wherein said step of accepting event calendar data via telephone service comprises the step of accepting event calendar data via a service selected from a group consisting of telephony, a telephone service, a cellular service, a voice over IP service, and a web based voice service.

175. An event notification method as described in claim 164, wherein said step of automatically assigning comprises the step of computer assigning.

176. An event notification method as described in claim 164, wherein said step of automatically assigning comprises the step of creating a data association linking said event calendar data and said voice based calendar parameter.

177. An event notification method as described in claim 164, wherein said step of automatically transmitting comprises the step of automatically transmitting by telephone service.

178. An event notification method as described in claim 177, wherein said step of automatically transmitting by telephone service comprises the step of automatically transmitting by a service selected from a group consisting of telephony, a telephone service, a cellular service, a voice over IP service, and a web based voice service.

179. An event notification method as described in claim 164, wherein said step of automatically storing comprises the step of computer storing.

180. An event notification method as described in claim 164, further comprising the step of user receiving said voice based calendar parameter.

181. An event notification method as described in claim 180, wherein said step of user receiving said voice based calendar parameter comprises the step of user receiving said voice based calendar parameter via telephone service.

182. An event notification method as described in claim 181, wherein said step of user receiving said voice based calendar parameter via telephone service comprises the step of user receiving said voice based calendar parameter via a service selected from a group consisting of telephony, a telephone service, a cellular service, a voice over IP service, and a web based voice service.

183. An event notification method as described in claim 180, wherein said step of user receiving said at least one voice based calendar parameter comprises the step of user receiving multiple voice based calendar parameters.

184. An event notification method as described in claim 183, further comprising the step of sorting said multiple voice based calendar parameters.

185. An event notification method as described in claim 183, further comprising the step of user navigating said multiple voice based calendar parameters.

186. An event notification method as described in claim 180, further comprising the step of user evaluating said at least one voice based calendar parameter.

187. An event notification method as described in claim 186, further comprising the step of user determining a need to review said event calendar data based on said evaluation of said at least one voice based calendar parameter.

188-206. (canceled)
